(19) United States
(12) Patent Application Publication
(10) Pub. No.: US 2024/0385880 A1
(43) Pub. Date: Nov. 21, 2024

(54) TASK SCHEDULING UNIT, WAFER-SCALE CHIP, AND TASK SCHEDULING METHOD

(71) Applicant: Alibaba Innovation Private Limited, Singapore (SG)

(72) Inventors: Youwei ZHUO, Beijing (CN); Han XU, Beijing (CN); Zhe ZHANG, Beijing (CN); Shuangchen LI, Sunnyvale, CA (US); Dimin NIU, Sunnyvale, CA (US); Hongzhong ZHENG, Los Gatos, CA (US)

(21) Appl. No.: 18/667,409

(22) Filed: May 17, 2024

(30) Foreign Application Priority Data
May 19, 2023 (CN) 202310575109.7

(51) Int. Cl. G06F 9/48

(52) U.S. Cl. CPC G06F 9/4887

(57) ABSTRACT

A task scheduling unit includes a progress detection subunit having circuitry configured to obtain first progress information of a first chip in which the task scheduling unit is located, the first progress information indicating a task execution progress of the first chip; a transmission subunit having circuitry configured to transmit the first progress information to a second chip, wherein the first chip and the second chip are located on a same wafer, and the task execution progress of the first chip is less than a task execution progress of the second chip; and a transfer subunit having circuitry configured to receive first request information transmitted by the second chip in response to the first progress information; and transfer at least some of tasks executed by the first chip to the second chip for execution based on the first request information.

### CROSS-REFERENCE TO RELATED APPLICATIONS

The disclosure claims the benefits of priority to Chinese Application No. 202310575109.7, filed May 19, 2023, which is incorporated herein by reference in its entirety.

### TECHNICAL FIELD

The present disclosure generally relates to chips, and more particularly, to a task scheduling unit, a wafer-scale chip, and a task scheduling method.

### BACKGROUND

A wafer-scale chip includes a network on chip (NoC) and a plurality of chips on a wafer. The NoC connects the chips together, so that the chips may communicate with each other reliably. In a manufacturing process of wafer-scale chips, due to reasons such as a wafer surface defect and an integration process, some chips on the wafer may have defects. The operation capability of a defective chip is lower than that of a normal chip.

At present, manufacturers of wafer-scale chips find defective chips on the wafer during wafer-scale chip testing, disable the defective chips, and use only non-defective chips on the wafer-scale chip.

However, disabling the defective chips on the wafer-scale chip and using only non-defective chips may cause low utilization of the chips on the wafer-scale chip, resulting in low operation efficiency of the wafer-scale chip.

### SUMMARY OF THE DISCLOSURE

Embodiments of the present disclosure provide a task scheduling unit. The task scheduling unit includes: a progress detection subunit having circuitry configured to obtain first progress information of a first chip in which the task scheduling unit is located, the first progress information indicating a task execution progress of the first chip; a transmission subunit having circuitry configured to transmit the first progress information to a second chip, wherein the first chip and the second chip are located on a same wafer, and the task execution progress of the first chip is less than a task execution progress of the second chip; and a transfer subunit having circuitry configured to: receive first request information transmitted by the second chip in response to the first progress information; and transfer at least some of tasks executed by the first chip to the second chip for execution based on the first request information, wherein the first request information is generated by the second chip based on the first progress information and the task execution progress of the second chip.

Embodiments of the present disclosure provide a task scheduling method. The method includes: obtaining first progress information of a first chip, wherein the first progress information indicates a task execution progress of the first chip; transmitting the first progress information to a second chip, wherein the first chip and the second chip are located on a same wafer, and the task execution progress of the first chip is less than a task execution progress of the second chip; receiving first request information transmitted by the second chip in response to the first progress information, wherein the first request information is generated by the second chip based on the first progress information and the task execution progress of the second chip; and transferring at least some of tasks executed by the first chip to the second chip for execution based on the first request information.

Embodiments of the present disclosure provide a wafer-scale chip. The wafer-scale chip includes a plurality of chips. Each of the plurality of chips includes the above task scheduling unit. The plurality of chips communicate with each other through a network on chip.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram of an exemplary computing device, according to some embodiments of the present disclosure.

FIG. 2 is a schematic diagram of an exemplary wafer-scale chip, according to some embodiments of the present disclosure.

FIG. 3 is a schematic diagram of an exemplary chip, according to some embodiments of the present disclosure.

FIG. 4 is a schematic diagram of an exemplary task scheduling unit, according to some embodiments of the present disclosure.

FIG. 5 is a schematic diagram of exemplary chip information interaction, according to some embodiments of the present disclosure.

FIG. 6 is a schematic diagram of another an exemplary chip information interaction, according to some embodiments of the present disclosure.

FIG. 7 is a flowchart of an exemplary task scheduling method, according to some embodiments of the present disclosure.

FIG. 8 is a flowchart of another exemplary task scheduling method, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

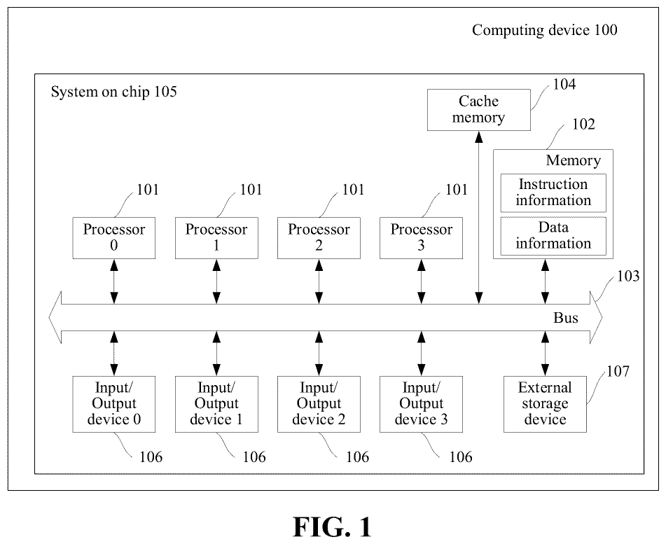

FIG. 1 is a schematic diagram of an exemplary computing device 100, according to some embodiments of the present disclosure. As shown in FIG. 1, the computing device 100 may include a plurality of processors 101. As an example, as shown in FIG. 1, the computing device 100 may include a processor 0, a processor 1, a processor 2, and a processor 3. However, it should be understood that the number of processors 101 should not be limited thereto.

As shown in FIG. 1, the computing device 100 may further include a memory 102. The memory 102 in the computing device 100 may be a main memory (referred to as a main memory or a memory), and may be configured to store instruction information and/or data information represented by a data signal, for example, fetch data (for example, an operation result) provided by the processor 101, or may be configured to implement data exchange between the processor 101 and an external storage device 107 (also referred to as an auxiliary memory or an external memory).

In some cases, the processor 101 may need to access the memory 102 to obtain data in the memory 102 or to modify data in the memory 102. Since an access speed of the memory 102 is slow, to alleviate a speed gap between the processor 101 and the memory 102, the computing device 100 further includes a cache memory 104 coupled to a bus 103. The cache memory 104 is configured to cache some program data or message data that may be repeatedly called in the memory 102. The cache memory 104 may be implemented by a type of a storage device such as a static random-access memory (SRAM). The cache memory 104 may be a multi-level structure, for example, a three-level cache structure with first-level cache (L1 cache), second-level cache (L2 cache), and third-level cache (L3 cache), or may be a cache structure above third level or a cache structure of another type. In some embodiments, a part (for example, L1 cache, or L1 cache and L2 cache) of the cache memory 104 may be integrated in the processor 101 or integrated with the processor 101 on the same system on chip.

Information interaction between the memory 102 and the cache memory 104 is usually organized in blocks. In some embodiments, the cache memory 104 and the memory 102 may be divided into data blocks based on the same space size, and the data blocks may be used as units (including one or more data of a preset length) of data exchange between the cache memory 104 and the memory 102. For concise and clear description, each data block in the cache memory 104 is referred to as a cache block (may be referred to as a cache line or a cache line) in the following, and different cache blocks have different cache block addresses. Each data block in the memory 102 is briefly referred to as a memory block, and different memory blocks have different memory block addresses. The cache block address includes, for example, a physical address tag used for locating a data block.

Due to space and resource limitations, the cache memory 104 cannot cache all content in the memory 102, that is, a storage capacity of the cache memory 104 is usually less than that of the memory 102, and the cache block addresses provided by the cache memory 104 cannot correspond to all memory block addresses provided by the memory 102. When the processor 101 needs to access the memory, the processor 101 first accesses the cache memory 104 through the bus 103 to determine whether to-be-accessed content is stored in the cache memory 104. If the content is stored in the cache memory 104, the cache memory 104 is hit, and in this case, the processor 101 directly calls the to-be-accessed content from the cache memory 104. If the content that the processor 101 needs to access is not stored in the cache memory 104, the processor 101 needs to access the memory 102 through the bus 103 to search the memory 102 for corresponding information. Since an access rate of the cache memory 104 is very fast, when the cache memory 104 is hit, the efficiency of the processor 101 may be significantly improved, thereby improving the performance and efficiency of the entire computing device 100.

As shown in FIG. 1, the processor 101, the cache memory 104, and the memory 102 are encapsulated in a system on chip (SoC) 105. A designer may configure an SoC architecture, so that communication between elements in the computing device 100 is secure. The processor 101 may be a wafer-scale chip, and the system on chip 105 may include one or more wafer-scale chips, which is not limited in the present disclosure. Wafer-scale chip is a chip integration including a plurality of chips formed on the same wafer. The chips included in the wafer-scale chip communicate through a network on chip. Due to a short distance between the chips, the wafer-scale chip has a stronger data processing capability and speed.

The computing device 100 may further include hardware devices such as a display device (not shown), an audio device (not shown), an input/output device 106, and the like. The input/output device 106 may be, for example, an input/output device of text, audio, and video. As an example, FIG. 1 shows an input/output device 0, an input/output device 1, an input/output device 2, and an input/output device 3. However, it should be understood that the number of input/output devices should not be limited thereto. The storage device is, for example, a device for information access such as a hard disk, an optical disk, and a flash memory that is coupled to the bus 103 through a corresponding interface. The display device is, for example, coupled to the bus 103 through a corresponding graphics card, and is configured to display based on a display signal provided by the bus 103. The computing device 100 usually further includes a communication device (not shown), so that the computing device may communicate with a network or another device in various manners. The communication device may, for example, include one or more communication modules. As an example, the communication device may include a wireless communication module adapted to a specific wireless communication protocol. For example, the communication device may include a wireless local-area network (WLAN) module, configured to implement Wi-Fi communication in compliance with the 802.11 standard made by the Institute of Electrical and Electronics Engineers (IEEE). The communication device may further include a wireless wide-area network (WWAN) module, configured to implement wireless wide area communication in compliance with cellular or another wireless wide area protocol. The communication device may further include a communication module using another protocol such as a Bluetooth module, or another communication module of customized type. The communication device may further be a port for serial transmission of data.

It should be understood that the computing device 100 shown in FIG. 1 is an exemplary structure, and structures of different computer systems may vary due to different mainboards, operating systems, and instruction set architectures.

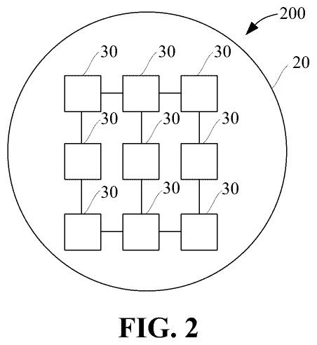

FIG. 2 is a schematic diagram of an exemplary wafer-scale chip 200, according to some embodiments of the present disclosure. The wafer-scale chip 200 includes a wafer 20 and a plurality of chips 30 arranged on the wafer 20. The chips 30 communicate with each other through a network on chip (NoC). Network on chip (NoC) is a new communication method for a system on chip (SoC). The network on chip connects a plurality of chips on a chip, so that the chips may communicate with each other reliably. A topology structure that may be constructed by the chips included in the network on chip includes a 2D/3D mesh network (Mesh), a torus network (Torus), a ring network, and the like. The chip 30 may be a central processing unit (CPU), a graphics processing unit (GPU), an infrastructure processing unit (IPU), or the like. The chip 30 may include one or more processor cores, and different processor cores communicate with each other through the network on chip. The chip 30 may include one or more process elements (PE). The process element (PE) is a logic core of the processor, and one logic core may run one thread. The process element (PE) includes a plurality of operation units, such as an arithmetic logic unit (ALU), a floating point unit (FPU), a matrix multiplication unit, and the like. The operation units communicate with each other through the network on chip.

The wafer-scale chip 200 is a chip integration including a plurality of chips 30 prepared from a silicon wafer, and the chips 30 may communicate with each other through the network on chip. In a manufacturing process of wafer-scale chips, due to reasons such as a wafer surface defect and an integration process, some chips on a manufactured wafer-scale chip may have defects or are unable to work. The operation capability of a defective chip is lower than that of a normal chip. Different chips may have different defects. For example, some defective chips have a lower speed for an addition operation but a normal speed for a multiplication operation. Some other defective chips have a lower speed for a multiplication operation but a normal speed for an addition operation. For ease of description, a chip with defects on the wafer-scale chip is defined as a defective chip in the following description.

To make full use of the operation capability of the wafer-scale chip, the defective chip on the wafer-scale chip may be enabled to perform task processing. However, due to the low operational speed of the defective chip, while assigning the same number of tasks, the defective chip takes longer to complete the assigned tasks than the normal chip. In the embodiments of the present disclosure, to ensure timeliness of task processing, the defective chip may detect a task execution progress during task execution and transmit progress information for indicating the task execution progress to the normal chip. Progress information is used for indicating a task execution progress of a chip. After assigning a task to the chip, a control unit of a system may detect a task progress of the chip to determine the task execution progress of the chip. The task execution progress of the chip may be the number of completed tasks, a percentage of the number of completed tasks in the total number of tasks, and the like. After receiving the progress information, the normal chip may determine a task execution progress of the defective chip, and then based on the task execution progress of the normal chip and the task execution progress of the defective chip, transmit request information to the defective chip to request to transfer some of tasks assigned to the defective chip to the normal chip for execution. The defective chip may transfer some tasks to the normal chip for execution in response to the received request information, thereby making full use of the operation capability of the wafer-scale chip when the wafer-scale chip is working at full load and improving capability of the wafer-scale chip for task processing.

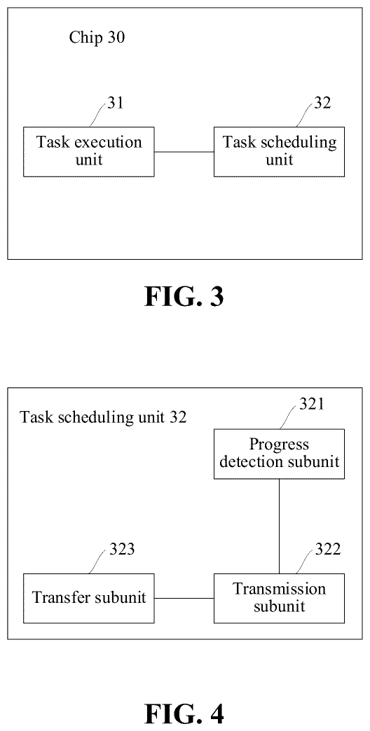

FIG. 3 is a schematic diagram of an exemplary chip 30, according to some embodiments of the present disclosure. As shown in FIG. 3, the chip 30 includes a task execution unit 31 and a task scheduling unit 32 . . . . The task execution unit 31 is connected to the task scheduling unit 32 through a bus. A task assigned to the chip, for example, an operation task and a read-write task, may be executed. The task scheduling unit 32 includes circuitry configured to detect the task execution progress during task execution by the task execution unit, and transmit progress information for indicating the task execution progress to another chip located on the same wafer, and may receive request information transmitted by another chip, so that some of the tasks executed by the task execution unit may be transferred to the task execution unit in another chip based on the request information. In this way, the task scheduling function of the task scheduling unit 32 is implemented, and some of the tasks of the chip with lower operation efficiency may be scheduled to the chip with higher operation efficiency for execution. Therefore, the chip with lower operation efficiency may be enabled, and the chip with lower operation efficiency is the defective chip in the wafer-scale chip. Compared with disabling the defective chip in the wafer-scale chip, utilization of the chip on the wafer-scale chip is improved, the operation capability of the wafer-scale chip may be fully utilized when the wafer-scale chip is working at full load, and the capability of the wafer-scale chip for task processing may be improved.

Some embodiments of the present disclosure mainly focus on the task scheduling process by the task scheduling unit 32. The following describes the task scheduling process by the task scheduling unit in detail.

Based on the chip 30 in the wafer-scale chip 200, some embodiments of the present disclosure provide a task scheduling unit 32, and the task scheduling unit 32 is arranged in the chip 30. The following describes the task scheduling unit 32 in detail through a plurality of embodiments.

FIG. 4 is a schematic diagram of an exemplary task scheduling unit 32, according to some embodiments of the present disclosure. As shown in FIG. 4, the task scheduling unit 32 includes a progress detection subunit 321, a transmission subunit 322, and a transfer subunit 323.

The progress detection subunit 321 includes circuitry configured to obtain first progress information of a first chip in which the task scheduling unit 32 is located. The first progress information is used for indicating a task execution progress of the first chip. The transmission subunit 322 includes circuitry configured to transmit the first progress information to a second chip. The first chip and the second chip are located on the same wafer, and the task execution progress of the first chip is less than a task execution progress of the second chip. The transfer subunit 323 includes circuitry configured to receive first request information transmitted by the second chip in response to the first progress information, and transfer at least some of tasks executed by the first chip to the second chip for execution based on the first request information. The first request information is generated by the second chip based on the first progress information and the task execution progress of the second chip.

After receiving a task, the wafer-scale chip assigns the task to a plurality of chips arranged on the wafer-scale chip 200 (as shown in FIG. 2) for processing through a controller arranged on the wafer-scale chip 200. The progress detection subunit 321 may detect the first progress information of the first chip in which the task scheduling unit 32 is located to obtain the task execution progress of the first chip. The first progress information may be a task completion percentage, command execution times, or the like. For example, if the first chip is assigned 1000 tasks, and in this case, 200 tasks are completed, the first progress information may be 20%, thereby indicating the task execution progress of the first chip as 20%. Alternatively, if the first chip is assigned 1000 tasks, the 1000 tasks include 2000 commands, and in this case, the first chip has executed 1000 commands, the 1000 commands that have been executed are determined as the task execution progress of the first chip.

The task execution efficiency of the chip may be determined based on the task execution progress of the chip. When two chips process their own corresponding task respectively, a difference in the operational speed between the two chips may be determined by comparing the task execution progresses of the two chips, so that the chip with a slower operational speed, that is, the defective chip, may be determined.

After obtaining the first progress information, the transmission subunit 322 transmits the first progress information to the second chip on the same wafer. The task execution progress of the second chip is greater than the task execution progress of the first chip, that is, the first chip is a defective chip, which causes the operational speed of the first chip to be lower than the operational speed of the second chip. The task execution progress of the second chip is detected by the progress detection subunit arranged on the second chip. The transmission subunit 322 on the first chip may transmit the first progress information to the second chip through the network on chip. A specific information transmission method is not limited in the embodiments of the present disclosure.

After receiving the first progress information transmitted by the transmission subunit 322, the second chip transmits first request information to the first chip based on the task execution progress of the first chip indicated by the first progress information and the task execution progress of the second chip. The first request information indicates the number of tasks requested to transfer. In this case, the transfer subunit 323 arranged on the first chip receives the first request information transmitted by the second chip, and transfers at least some of tasks executed by the first chip to the second chip for execution based on the number of tasks the first request information requests to transfer.

In some embodiments, the progress detection subunit 321 may detect a task execution progress of a first chip, the transmission subunit 322 may transmit first progress information for indicating the task execution progress to a second chip, and the transfer subunit may receive first request information transmitted by the second chip, so that some of tasks executed by the first chip may be transferred to the second chip for execution based on the first request information. The operation efficiency of the first chip is lower than that of the second chip, which allows some of tasks of a chip with lower operation efficiency to be scheduled to a chip with higher operation efficiency. Since the chip with lower operation efficiency is enabled, and the chip with lower operation efficiency is a defective chip in the wafer-scale chip, compared with disabling the defective chip in the wafer-scale chip, the utilization of the chip on the wafer-scale chip is improved, and an overall operational speed of the wafer-scale chip is not reduced due to the enabling of the defective chip, so that the operation efficiency of the wafer-scale chip is improved.

In some embodiments, the progress detection subunit 321 may detect the number of completions of an operation loop in the first chip, and determine the number of completions as the first progress information, where the operation loop includes at least one operation instruction.

The progress detection subunit 321 may obtain the task execution progress in the first chip through counting. The progress detection subunit 321 detects the number of operation loops in the first chip. One operation loop includes at least one operation instruction. For example: an operation loop is numerical calculation. In this case, the operation loop includes a plurality of addition, subtraction, multiplication, and division operations. The progress detection subunit 321 performs counting based on the number of completions of the operation loop, and determines a count value as the first progress information.

Correspondingly, in this case, the progress detection subunit in the second chip detects the task execution progress of the second chip through the same method, that is, the progress detection subunit in the second chip records the task execution progress of the second chip through counting. After the second chip receives the first progress information transmitted by the first chip, the second chip transmits the first request information to the first chip based on the count indicated by the first progress information and the count of the progress detection subunit in the second chip.

The progress detection subunit 321 may detect the number of completions of the operation loop through hardware or software. In an example, the progress detection subunit 321 may implicitly declare a local variable named progress_counter for each thread in the chip through the OpenMP language, and associate the variable with an operation loop count to detect and record the task execution progress.

In some embodiments, the progress detection subunit 321 detects the number of completions of the operation loop in the first chip, and determines the number of completions as the first progress information. In this way, the task execution progress of the first chip may be detected, and the task execution progress of the first chip may be represented as a specific value, so that the second chip transmits the first request information based on the task execution progress of the first chip and the task execution progress of the second chip, which improves the efficiency of data interaction between the first chip and the second chip, thereby improving the efficiency of task transfer.

In a possible implementation, the transfer subunit 323 may transmit first transfer information to the second chip, so that the second chip executes a task of transferring from the first chip to the second chip based on the first transfer information.

When receiving the first request information transmitted by the second chip, the transfer subunit 323 of the first chip transfers at least some of the tasks executed by the first chip to the second chip for execution through the first transfer information. The first transfer information may include at least one of information about a to-be-transferred task and a data storage address of the to-be-transferred task. For example, if the to-be-transferred task is a computing task, the first transfer information may include task information. If the to-be-transferred task is a read-write task, the first transfer information may include task information and a data storage address of the task to execute reading and writing of data.

It should be noted that, after transmitting the first transfer information, the first chip deletes the task corresponding to the first transfer information to prevent the first chip and the second chip from executing the same task. After receiving the first transfer information, the second chip parses the first transfer information to obtain tasks transferred out by the first chip and included in the first transfer information, and then executes the tasks transferred out by the first chip based on the first transfer information, thereby implementing the task transfer.

In some embodiments, the transfer subunit 323 transfers at least some of the tasks executed by the first chip to the second chip for execution by transmitting the first transfer information to the second chip, so that some tasks of the chip with lower operation efficiency are transferred to the chip with higher operation efficiency for execution, thereby shortening the time to complete the tasks and improving the overall operation efficiency of the wafer-scale chip 200. The tasks are transferred by transferring information, and there is no need to transfer task data, which improves the efficiency of task transfer.

In some embodiments, the transfer subunit 323 may determine to-be-transferred tasks that need to be transferred to the second chip based on the number of tasks the first request information requests to transfer and the number of to-be-executed tasks of the first chip, and transfer the to-be-transferred tasks to the second chip for execution, where the number of the to-be-transferred tasks is less than the number of the to-be-executed tasks.

After receiving the first request information, the transfer subunit 323 parses the first request information to determine the number of tasks the first request information requests to transfer. Then, the transfer subunit 323 obtains the number of to-be-executed tasks in the first chip, determines the to-be-transferred tasks based on the number of to-be-executed tasks and the number of tasks requested to transfer, and transfers the to-be-transferred tasks to the second chip for execution. Since the to-be-transferred tasks are at least some of the tasks in the first chip, the number of to-be-transferred tasks is less than the number of to-be-executed tasks in the first chip.

The number of to-be-transferred tasks may be less than or equal to the number of tasks the first request information requests to transfer. Since the number of tasks the first request information requests to transfer may be greater than the number of to-be-executed tasks of the first chip, the determined number of to-be-transferred tasks may be less than the number of tasks the first request information requests to transfer, and when a difference between the number of to-be-executed tasks of the first chip and the number of tasks requested to transfer is small, the number of to-be-transferred tasks may be smaller than the number of tasks requested to be transferred by the first request information.

The number of to-be-transferred tasks may further be greater than the number of tasks requested to be transferred by the first request information. When the number of tasks requested to be transferred by the first request information is small and the number of to-be-executed tasks of the first chip is large, the number of to-be-transferred tasks may be greater than the number of tasks the first request information requests to transfer. For example: if there are 1000 to-be-executed tasks, and the number of tasks the first request information requests to transfer is 100, in this case, 200 to-be-executed tasks may be transferred to the second chip for execution based on the task execution progress of the first chip and the task execution progress of the second chip.

It should be noted that the foregoing task transfer process may be implemented by transmitting transfer information to the second chip in the previous embodiments, or may be implemented in another manner, for example: in manners such as reassigning tasks by a controller. This is not limited in the embodiments of the present disclosure.

In some embodiments, the to-be-transferred tasks that need to be transferred to the second chip are determined based on the number of tasks the first request information requests to transfer and the number of to-be-executed tasks of the first chip, and the to-be-transferred tasks are transferred to the second chip for execution, thereby determining the to-be-transferred tasks and implementing the task transfer. Since the to-be-transferred tasks are determined based on the number of tasks requested to transfer and the number of to-be-executed tasks, that is, the first chip determines the number of to-be-transferred tasks based on the number of tasks the second chip can process, at least some of the to-be-executed tasks of the first chip may be transferred to the second chip for execution when the execution of original tasks by the second chip is not affected, thereby shortening the time to complete the tasks and improving the operation efficiency of the wafer-scale chip 200 in which the first chip and the second chip are located.

In some embodiments, the transfer subunit 323 may receive second progress information transmitted by a third chip, where the first chip and the third chip are located on the same wafer. The transmission subunit 322 may determine a task execution progress of the third chip based on the second progress information, and transmit second request information to the third chip when the task execution progress of the third chip and the task execution progress of the first chip satisfy a task transfer condition, to request to transfer at least some of tasks executed by the third chip to the first chip for execution.

The transfer subunit 323 receives the second progress information transmitted by the third chip located on the same wafer, where the second progress information is used for indicating the task execution progress of the third chip. After receiving the second progress information, the transfer subunit 323 transmits the second progress information to the transmission subunit 322. After receiving the second progress information transmitted by the transfer subunit 323, the transmission subunit 322 parses the second progress information to determine the task execution progress of the third chip, and compares the task execution progress of the third chip with the task execution progress of the first chip in which the transmission subunit 322 is located. When a comparison result satisfies the task transfer condition, the transmission subunit 322 transmits the second request information to the third chip, so that at least some of the tasks executed by the third chip may be transferred to the first chip for execution.

It should be noted that, when the task execution progress of the third chip determined by the transmission subunit 322 is lower than the task execution progress of the first chip in which the transmission subunit 322 is located, the second request information is not transmitted to the third chip, so that the third chip cannot receive the second request information, and the third chip continues to process the to-be-executed task of the third chip and does not transfer the task out. However, when the task execution progress of the third chip determined by the transmission subunit 322 is greater than the task execution progress of the first chip in which the transmission subunit 322 is located, and the task transfer condition is satisfied, the second request information is transmitted to the third chip, and at least some of the tasks executed by the third chip are transferred to the first chip for execution.

In the embodiments of the present disclosure, the transfer subunit 323 receives the second progress information of the third chip, so that the second request information may be transmitted to the third chip based on the task execution progress of the third chip and the task execution progress of the first chip. In this way, some tasks of the chip with lower operation efficiency may be transferred to the chip with higher operation efficiency for processing. Therefore, the defective chip may be utilized and there is no need to disable the defective chip, which improves the utilization of the chips on the wafer-scale chip 200, thereby improving the operation efficiency of the wafer-scale chip 200 in which the first chip and the third chip are located.

In some embodiments, the transfer subunit 323 may receive second transfer information transmitted by the third chip in response to the second request information, and execute a task of transferring from the third chip to the first chip based on the second transfer information.

When the task execution progress of the third chip and the task execution progress of the first chip satisfies the task transfer condition, the first chip transmits the second request information to the third chip. After receiving the second request information, the third chip generates the second transfer information in response to the second request information, where the second transfer information may indicate a task of transferring from the third chip to the first chip. In this case, the transfer subunit 323 in the first chip receives the second transfer information, and processes tasks transferred out by the third chip based on the second transfer information. The task execution progress of the third chip is greater than the task execution progress of the first chip.

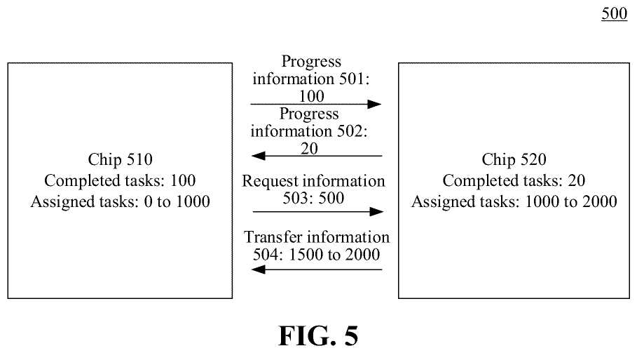

FIG. 5 shows an exemplary information interaction process 500 between chips, according to some embodiments of the present disclosure. As shown in FIG. 5, chip 510 is assigned task 0 to task 1000, chip 520 is assigned task 1000 to task 2000, the number of completed tasks for chip 510 is 100, and the number of completed tasks for chip 520 is 20. Chip 510 transmits progress information 501 of chip 510 to chip 520, and progress information 501 indicates the number of completed tasks for chip 510. After receiving progress information 501, chip 520 compares the number of completed tasks of chip 520 with progress information 501. Since the number of completed tasks of chip 520 is 20, which is less than the number of completed tasks of chip 510, chip 520 does not transmit request information to chip 510. Chip 520 transmits progress information 502 to chip 510, and progress information 502 indicates the number of completed tasks for chip 520. In this case, after receiving progress information 502, chip 510 transmits request information 503 to chip 520 based on the number 100 of completed tasks for chip 510 and the number 20 of completed tasks for chip 520, to request to transfer 500 tasks. Chip 520 transmits transfer information 504 to chip 510 in response to request information 503, and transfers task 1500 to task 2000 to chip 510 for execution. Chip 510 may execute task 1500 to task 2000 based on transfer information 504.

It should be understood that after chip 520 transfers task 1500 to task 2000 to chip 510 for execution, chip 520 only needs to execute the remaining task 1000 to task 1500 instead of t task 1500 to task 2000 to prevent repeated execution of tasks.

In some embodiments, the transfer subunit 323 receives the second transfer information transmitted by the third chip (not shown) in response to the second request information, and executes the task of transferring from the third chip to the first chip based on the second transfer information, so that some tasks of the chip with lower operation efficiency may be transferred to the chip with higher operation efficiency for processing. Therefore, the defective chip may be utilized and there is no need to disable the defective chip, which improves the utilization of the chips on the wafer-scale chip 100, thereby improving the operation efficiency of the wafer-scale chip 200 in which the first chip and the third chip are located.

In some embodiments, the task transfer condition includes: a difference between the task execution progress of the first chip and the task execution progress of the third chip is greater than an execution progress threshold; and/or a difference between a predicted time for the third chip to execute the remaining tasks and a predicted time for the first chip to execute the remaining tasks is greater than a time threshold.

The second request information is transmitted to the third chip when the task execution progress of the third chip and the task execution progress of the first chip satisfy the task transfer condition. The task transfer condition may include that a difference between the task execution progress of the first chip and the task execution progress of the third chip is greater than an execution progress threshold, and the execution progress threshold is a preset threshold. For example: A progress percentage difference 20% or a task progress count difference 20 may be set.

In an example, if a preset execution progress threshold is 30, a task progress count difference between the first chip and the third chip is 80, which is greater than the preset execution progress threshold. In this case, the first chip transmits the second request information, to the third chip.

The task transfer condition may further include that a difference between a predicted time for the third chip to execute the remaining tasks and a predicted time for the first chip to execute the remaining tasks is greater than a time threshold. Since each chip is assigned different tasks, the number of tasks may also vary, and there is some difference in operation efficiency of each chip, each chip may predict a time required to execute the remaining tasks based on the remaining tasks of each chip, completed tasks, and a time taken to complete the task. When the difference between the predicted time of the first chip and the predicted time of the third chip is greater than a preset time threshold, the first chip transmits the second request information to the third chip.

It should be understood that since there is some difference in performance between different chips, non-defective chips also have some difference when processing the same task. For example, the first chip needs 100s to process 1000 tasks, and the third chip needs 105s to process 1000 tasks. Alternatively, the first chip has completed 50 tasks, and the third chip has completed 48 tasks. In the foregoing two examples, although the task execution progress of the third chip is less than the task execution progress of the first chip, due to the small difference, the tasks of the third chip are not transferred to the first chip for execution. Therefore, a threshold needs to be set to screen out chips with a large progress difference for task transfer.

In some embodiments, the task transfer condition includes that a difference in task execution progress is greater than the execution progress threshold, or a difference in predicted time for executing the remaining tasks is greater than the time threshold. In this way, chips with large difference in task execution progress may be screened out for task transfer between chips with a large difference in task execution progress. This avoids a situation in which the task transfer between chips with a small progress difference occupies bandwidth and reduces the operation efficiency. In addition, the defective chip may be utilized for operation in the task transfer between chips with a large difference in task execution progress, and there is no need to disable the defective chip, which improves the utilization of the chips on the wafer-scale chip 100, thereby improving the operation efficiency of the wafer-scale chip 100 in which the first chip and the third chip are located.

In a possible implementation, the transmission subunit 322 may transmit to-be-transmitted information to a target chip located on the same wafer as the first chip through broadcasting; and/or attach the to-be-transmitted information to interaction data between the first chip and the target chip.

The transmission subunit 322 may transmit the to-be-transmitted information to another chip on the same wafer through broadcasting. The to-be-transmitted information may include any information transmitted by the first chip according to any one of the foregoing embodiments, for example: the first progress information and the second request information. The first progress information is used as an example. The first chip broadcasts the first progress information. In this case, another chip located on the same wafer may receive the broadcast of the first progress information, and may determine whether to transmit the request information to the first chip to request the first chip to transfer the tasks based on the task execution progress of the first chip indicated by the first progress information and the task execution progress of the another chip.

It should be noted that, when the to-be-transmitted information of the first chip is transmitted through broadcasting, a plurality of chips located on the same wafer may receive the broadcast information, so that the first chip may receive a plurality of pieces of request information transmitted by the plurality of chips located on the same wafer. In this case, the first chip may assign the tasks to the plurality of chips for execution based on the plurality of pieces of request information. A specific assignment method is not described in the present disclosure again.

The transmission subunit 322 may further attach the to-be-transmitted information to communication data with the target chip. In this case, the first chip and the target chip are connected through the NoC and communicate through the NoC. After the communication data attached with the to-be-transmitted information is transmitted to the target chip through the NoC, the target chip may attach the request information to the communication data during next data interaction, to transmit the request information to the first chip.

In some embodiments, when the to-be-transmitted information is attached to interaction data between the first chip and the target chip for information interaction, a regular broadcast may be set, and the to-be-transmitted information is transmitted through broadcasting regularly.

Since data interaction is not performed in real time, it is possible that unidirectional data interaction is performed once in a long time. In this case, after the first chip attaches the to-be-transmitted information to the interaction data and performs data communication with the target chip, information returned by the target chip is not received until the next data interaction between the target chip and the first chip, so that the timeliness of information interaction is poor.

Therefore, a regular broadcast function is set, and the to-be-transmitted information in the chip is transmitted through broadcasting at every fixed time interval. In this case, a message may be replied to in time, and there is no need to wait for the next data interaction to receive a reply message. Therefore, the timeliness of information interaction between the first chip and the target chip may be improved.

In some embodiments, the first chip transmits the to-be-transmitted information to the target chip through broadcasting. In this way, information interaction between chips may be implemented, a chip with lower task execution efficiency is allowed to communicate with a chip with higher task execution efficiency, and therefore, task transfer between chips may be performed. In addition, the first chip may exchange information through data interaction by attaching the to-be-transmitted information to the interaction data with the target chip. Since data interaction needs to be performed between the first chip and target information, the information interaction does not occupy new bandwidth, so that the task processing efficiency of the chips is improved, thereby improving the operation efficiency of the wafer-scale chip 200.

In some embodiments, the transfer subunit 323 may receive information transmitted by a source chip located on the same wafer as the first chip through broadcasting, or parse the information transmitted by the source chip to the first chip from interaction data transmitted by the source chip to the first chip.

In some embodiments, a source chip is the chip that transfers tasks to other chip to process, and a target chip is the chip that receives the task from other chip to process.

The transfer subunit 323 may receive the information transmitted by the source chip through broadcasting. The information may include any information received by the first chip according to any one of the foregoing embodiments, for example: the second progress information and the first request information. The interaction data may further be parsed to obtain information added by the source chip to the interaction data, to perform information interaction with the source chip.

In some embodiments, the first chip may implement information interaction between chips by receiving information transmitted by the source chip through broadcasting. In this way, information interaction between chips may be implemented, the chip with lower task execution efficiency is allowed to communicate with the chip with higher task execution efficiency, and task transfer between the chips is performed. In addition, the first chip may obtain the information added by the source chip to the interaction data by parsing the interaction data, information interaction and task transfer are implemented between the defective chip and the normal chip, so that the defective chip participates in the operation, thereby improving the operation efficiency of the wafer-scale chip 200.

In a possible implementation, a chip with lower operation efficiency may be pre-determined, only the chip with lower operation efficiency is allowed to transmit its own task execution progress, and a normal chip does not transmit its own task execution progress. After the task execution progress is received, only the normal chip is allowed to transmit request information, and the chip with lower operation efficiency does not transmit the request information, to transfer at least some of the tasks of the chip with lower task execution efficiency to the chip with higher operation efficiency for execution.

After receiving the task execution progress, the chip compares the task execution progress with the task execution progress of the chip, and transmits the request information only when the task execution progress is less than the task execution progress of the chip and the task transfer condition is satisfied. Therefore, the defective chips on the same wafer may be determined during chip testing, and only the defective chips are allowed to transmit their own task execution progress to the outside, thereby reducing information interaction.

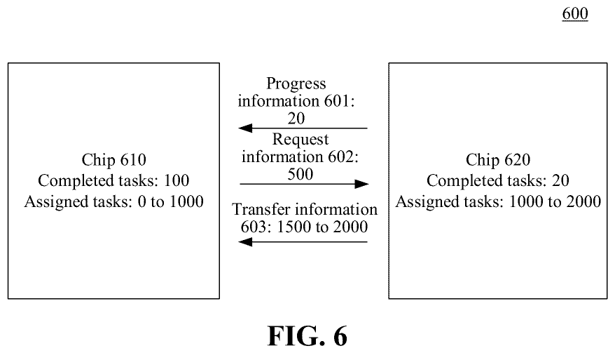

FIG. 6 shows an exemplary information interaction process 600 between a defective chip and a normal chip, according to some embodiments of the present disclosure. As shown in FIG. 6, chip 610 is assigned task 0 to task 1000, chip 620 is assigned task 1000 to task 2000, the number of completed tasks for chip 610 is 100, and the number of completed tasks for chip 620 is 20. Since chip 620 is pre-determined to be a defective chip, only chip 620 transmits progress information 601 to chip 610. In this case, after receiving progress information 601, chip 610 transmits request information 602 to chip 620 to request to transfer 500 tasks based on the number 100 of completed tasks for chip 610 and the number 20 of completed tasks for chip 620. Chip 620 transmits transfer information 603 to chip 610 in response to request information 602, and transfers task 1500 to task 2000 to chip 610 for execution. Chip 610 may execute task 1500 to task 2000 based on transfer information 603.

In some embodiments, the defective chip is pre-determined and only the defective chip is allowed to transmit the task execution progress to the outside, which may reduce information interaction between the normal chip and the defective chip. Therefore, more bandwidth may be used for task execution, and the time for task execution is shortened, thereby improving the operation efficiency of the wafer-scale chip 200.

Based on the foregoing task scheduling unit 32, some embodiments of the present disclosure provide a task scheduling method. The task scheduling method may be executed by the task scheduling unit 32 according to any one of the foregoing embodiments.

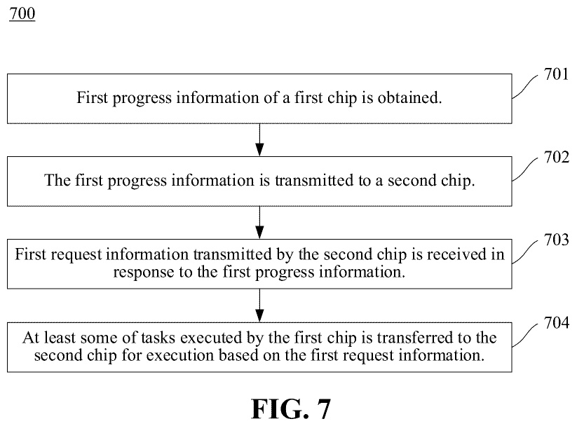

FIG. 7 is a flowchart of an exemplary task scheduling method 700, according to some embodiments of the present disclosure. As shown in FIG. 7, the task scheduling method includes steps 701 to 703.

At step 701, first progress information of a first chip is obtained.

The first progress information is detected by a progress detection subunit arranged on the first chip, and the first progress information is used for indicating a task execution progress of the first chip.

At step 702, the first progress information is transmitted to a second chip.

The first chip and the second chip are located on the same wafer, and the task execution progress of the first chip is less than a task execution progress of the second chip.

At step 703, first request information transmitted by the second chip is received in response to the first progress information.

The first request information is generated by the second chip based on the first progress information and the task execution progress of the second chip.

At step 704, at least some of tasks executed by the first chip is transferred to the second chip for execution based on the first request information.

In some embodiments, the task execution progress is obtained, the first progress information used for indicating the task execution progress is transmitted to the second chip, and the first request information transmitted by the second chip is received, so that some of tasks executed by the first chip may be transferred to the second chip for execution based on the first request information. This allows some of tasks of a chip with lower operation efficiency to be scheduled to a chip with higher operation efficiency. Since the chip with lower operation efficiency is enabled, and the chip with lower operation efficiency is a defective chip in the wafer-scale chip, compared with disabling the defective chip in the wafer-scale chip, the utilization of the chip on the wafer-scale chip is improved, and an overall operational speed of the wafer-scale chip is not reduced due to the enabling of the defective chip, so that the operation efficiency of the wafer-scale chip is improved.

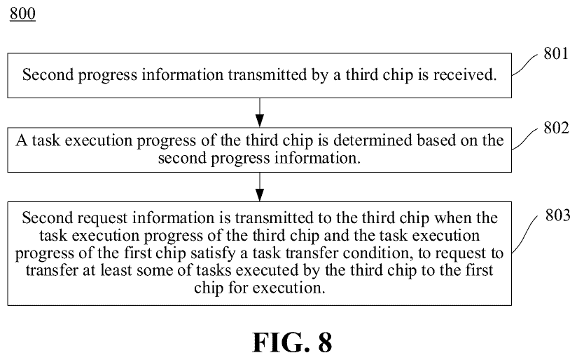

FIG. 8 is a flowchart of another exemplary task scheduling method 800, according to some embodiments of the present disclosure. As shown in FIG. 8, the task scheduling method 800 includes the steps 801 to 803.

At step 801, second progress information transmitted by a third chip is received.

The first chip and the third chip are located on the same wafer.

At step 802, a task execution progress of the third chip is determined based on the second progress information.

At step 803, second request information is transmitted to the third chip when the task execution progress of the third chip and the task execution progress of the first chip satisfy a task transfer condition, to request to transfer at least some of tasks executed by the third chip to the first chip for execution.

In some embodiments, the second progress information of the third chip is received. In this way, the second request information may be transmitted to the third chip based on the task execution progress of the third chip and the task execution progress of the first chip, so that some tasks of the chip with lower operation efficiency may be transferred to the chip with higher operation efficiency for processing. Therefore, the defective chip may be utilized for operation and there is no need to disable the defective chip, which improves the utilization of the chips on the wafer-scale chip, improving the operation efficiency of the wafer-scale chip in which the first chip and the third chip are located.

It should be noted that the task scheduling method in the embodiments of the present disclosure is a specific application of the task scheduling unit in the previous embodiments. For the specific task scheduling method, reference may be made to the description in the foregoing task scheduling unit embodiments, and details are not described herein again.

It should be noted that, the user-related information (including, but not limited to, user equipment information, user personal information, and the like) and the data (including, but not limited to, sample data used for training a model, data used for analysis, stored data, displayed data, and the like) involved in the embodiments of the present disclosure all are information and data authorized by the user or fully authorized by each party. The collection, use, and processing of relevant data need to comply with relevant laws and regulations of relevant countries and regions, and corresponding operation portals are provided for the user to choose to authorize or refuse.

The embodiments may further be described using the following clauses:
1. A task scheduling unit, comprising:
a progress detection subunit having circuitry configured to obtain first progress information of a first chip in which the task scheduling unit is located, the first progress information indicating a task execution progress of the first chip;
a transmission subunit having circuitry configured to transmit the first progress information to a second chip, wherein the first chip and the second chip are located on a same wafer, and the task execution progress of the first chip is less than a task execution progress of the second chip; and
a transfer subunit having circuitry configured to:
   receive first request information transmitted by the second chip in response to the first progress information; and
   transfer at least some of tasks executed by the first chip to the second chip for execution based on the first request information, wherein the first request information is generated by the second chip based on the first progress information and the task execution progress of the second chip.
2. The task scheduling unit according to clause 1, wherein the progress detection subunit has circuitry configured to:
detect a number of completions of an operation loop in the first chip; and
determine the number of completions as the first progress information, wherein the operation loop comprises at least one operation instruction.
3. The task scheduling unit according to clause 1, wherein the transfer subunit has circuitry configured to transmit first transfer information to the second chip.
4. The task scheduling unit according to clause 1, wherein the transfer subunit has circuitry configured to:
determine to-be-transferred tasks that need to be transferred to the second chip based on a number of tasks that the first request information requests to transfer and a number of to-be-executed tasks of the first chip; and
transfer the to-be-transferred tasks to the second chip for execution, wherein the number of the to-be-transferred tasks is less than the number of the to-be-executed tasks.
5. The task scheduling unit according to clause 1, wherein the transfer subunit has circuitry configured to receive second progress information transmitted by a third chip, wherein the first chip and the third chip are located on the same wafer; and
the transmission subunit has circuitry configured to:
   determine a task execution progress of the third chip based on the second progress information; and
   transmit second request information to the third chip when the task execution progress of the third chip and the task execution progress of the first chip satisfy a task transfer condition, to request to transfer at least some of tasks executed by the third chip to the first chip for execution.
6. The task scheduling unit according to clause 5, wherein the transfer subunit has circuitry configured to:
receive second transfer information transmitted by the third chip in response to the second request information; and
execute a task of transferring from the third chip to the first chip based on the second transfer information.
7. The task scheduling unit according to clause 5, wherein the task transfer condition comprises:
a difference between the task execution progress of the first chip and the task execution progress of the third chip is greater than an execution progress threshold;
or
a difference between a predicted time for the second chip to execute the remaining tasks and a predicted time for the first chip to execute the remaining tasks is greater than a time threshold.
8. The task scheduling unit according to any one of clauses 1 to 7, wherein the transmission subunit has circuitry configured to:
transmit to-be-transmitted information to a target chip located on the same wafer as the first chip through broadcasting.
9. The task scheduling unit according to any one of clauses 1 to 7, wherein the transmission subunit has circuitry configured to:
attach to-be-transmitted information to interaction data between the first chip and a target chip located on the same wafer as the first chip.
10. The task scheduling unit according to any one of clauses 1 to 7, wherein the transfer subunit has circuitry configured to:
receive information transmitted by a source chip located on the same wafer as the first chip through broadcasting.
11. The task scheduling unit according to any one of clauses 1 to 7, wherein the transfer subunit has circuitry configured to:
parse information transmitted by a source chip to the first chip from interaction data transmitted by the source chip to the first chip, where the source chip and the first chip are located on a same wafer.
12. A task scheduling method, comprising:
obtaining first progress information of a first chip, wherein the first progress information indicates a task execution progress of the first chip;
transmitting the first progress information to a second chip, wherein the first chip and the second chip are located on a same wafer, and the task execution progress of the first chip is less than a task execution progress of the second chip;
receiving first request information transmitted by the second chip in response to the first progress information, wherein the first request information is generated by the second chip based on the first progress information and the task execution progress of the second chip; and
transferring at least some of tasks executed by the first chip to the second chip for execution based on the first request information.
13. The method according to claim 12, further comprising:
receiving second progress information transmitted by a third chip, wherein the first chip and the third chip are located on the same wafer;
determining a task execution progress of the third chip based on the second progress information; and
transmitting second request information to the third chip when the task execution progress of the third chip and the task execution progress of the first chip satisfy a task transfer condition, to request to transfer at least some of tasks executed by the third chip to the first chip for execution.
14. A chip, comprising the task scheduling unit according to any one of clauses 1 to 11.
15. A wafer-scale chip, comprising a plurality of chips according to clause 14, wherein the plurality of chips communicate with each other through a network on chip.
16. A computing device, comprising the wafer-scale chip according to clause 15.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A task scheduling unit, comprising:
a progress detection subunit having circuitry configured to obtain first progress information of a first chip in which the task scheduling unit is located, the first progress information indicating a task execution progress of the first chip;
a transmission subunit having circuitry configured to transmit the first progress information to a second chip, wherein the first chip and the second chip are located on a same wafer, and the task execution progress of the first chip is less than a task execution progress of the second chip; and
a transfer subunit having circuitry configured to:
receive first request information transmitted by the second chip in response to the first progress information; and
transfer at least some of tasks executed by the first chip to the second chip for execution based on the first request information, wherein the first request information is generated by the second chip based on the first progress information and the task execution progress of the second chip.

2. The task scheduling unit according to claim 1, wherein the progress detection subunit has circuitry configured to:
detect a number of completions of an operation loop in the first chip; and
determine the number of completions as the first progress information, wherein the operation loop comprises at least one operation instruction.

3. The task scheduling unit according to claim 1, wherein the transfer subunit has circuitry configured to transmit first transfer information to the second chip.

4. The task scheduling unit according to claim 1, wherein the transfer subunit has circuitry configured to:
determine to-be-transferred tasks that need to be transferred to the second chip based on a number of tasks that the first request information requests to transfer and a number of to-be-executed tasks of the first chip; and
transfer the to-be-transferred tasks to the second chip for execution, wherein the number of the to-be-transferred tasks is less than the number of the to-be-executed tasks.

5. The task scheduling unit according to claim 1, wherein the transfer subunit has circuitry configured to receive second progress information transmitted by a third chip, wherein the first chip and the third chip are located on the same wafer; and
the transmission subunit is further configured to:
determine a task execution progress of the third chip based on the second progress information; and
transmit second request information to the third chip when the task execution progress of the third chip and the task execution progress of the first chip satisfy a task transfer condition, to request to transfer at least some of tasks executed by the third chip to the first chip for execution.

6. The task scheduling unit according to claim 5, wherein the transfer subunit has circuitry configured to:
receive second transfer information transmitted by the third chip in response to the second request information; and
execute a task of transferring from the third chip to the first chip based on the second transfer information.

7. The task scheduling unit according to claim 5, wherein the task transfer condition comprises:
a difference between the task execution progress of the first chip and the task execution progress of the third chip is greater than an execution progress threshold;
or
a difference between a predicted time for the second chip to execute the remaining tasks and a predicted time for the first chip to execute the remaining tasks is greater than a time threshold.

8. The task scheduling unit according to claim 1, wherein the transmission subunit has circuitry configured to:
transmit to-be-transmitted information to a target chip located on the same wafer as the first chip through broadcasting.

9. The task scheduling unit according to claim 1, wherein the transmission subunit has circuitry configured to:
attach to-be-transmitted information to interaction data between the first chip and a target chip located on the same wafer as the first chip.

10. The task scheduling unit according to claim 1, wherein the transfer subunit has circuitry configured to:
receive information transmitted by a source chip located on the same wafer as the first chip through broadcasting.

11. The task scheduling unit according to claim 1, wherein the transfer subunit is configured to:
parse information transmitted by a source chip to the first chip from interaction data transmitted by the source chip to the first chip, where the source chip and the first chip are located on a same wafer.

12. A task scheduling method, comprising:
obtaining first progress information of a first chip, wherein the first progress information indicates a task execution progress of the first chip;
transmitting the first progress information to a second chip, wherein the first chip and the second chip are located on a same wafer, and the task execution progress of the first chip is less than a task execution progress of the second chip;
receiving first request information transmitted by the second chip in response to the first progress information, wherein the first request information is generated by the second chip based on the first progress information and the task execution progress of the second chip; and
transferring at least some of tasks executed by the first chip to the second chip for execution based on the first request information.

13. The method according to claim 12, further comprising:
receiving second progress information transmitted by a third chip, wherein the first chip and the third chip are located on the same wafer;
determining a task execution progress of the third chip based on the second progress information; and
transmitting second request information to the third chip when the task execution progress of the third chip and the task execution progress of the first chip satisfy a task transfer condition, to request to transfer at least some of tasks executed by the third chip to the first chip for execution.

14. A wafer-scale chip comprising a plurality of chips, wherein each of the plurality of chips comprises a task scheduling unit and the task scheduling unit comprises:
a progress detection subunit having circuitry configured to obtain first progress information of a first chip in which the task scheduling unit is located, the first progress information indicating a task execution progress of the first chip;
a transmission subunit having circuitry configured to transmit the first progress information to a second chip, wherein the first chip and the second chip are located on the same wafer, and the task execution progress of the first chip is less than a task execution progress of the second chip; and
a transfer subunit having circuitry configured to receive first request information transmitted by the second chip in response to the first progress information, and transfer at least some of tasks executed by the first chip to the second chip for execution based on the first request information, wherein the first request information is generated by the second chip based on the first progress information and the task execution progress of the second chip;
wherein the plurality of chips communicate with each other through a network on chip.

15. The wafer-scale chip according to claim 14, wherein the progress detection subunit has circuitry configured to:
detect a number of completions of an operation loop in the first chip; and
determine the number of completions as the first progress information, wherein the operation loop comprises at least one operation instruction.

16. The wafer-scale chip according to claim 15, wherein the transfer subunit has circuitry configured to transmit first transfer information to the second chip.

17. The wafer-scale chip according to claim 15, wherein the transfer subunit has circuitry configured to:
determine to-be-transferred tasks that need to be transferred to the second chip based on a number of tasks that the first request information requests to transfer and a number of to-be-executed tasks of the first chip; and
transfer the to-be-transferred tasks to the second chip for execution, wherein the number of the to-be-transferred tasks is less than the number of the to-be-executed tasks.

18. The wafer-scale chip according to claim 15, wherein the transfer subunit has circuitry configured to receive second progress information transmitted by a third chip, wherein the first chip and the third chip are located on the same wafer; and
the transmission subunit is further configured to:
determine a task execution progress of the third chip based on the second progress information; and
transmit second request information to the third chip when the task execution progress of the third chip and the task execution progress of the first chip satisfy a task transfer condition, to request to transfer at least some of tasks executed by the third chip to the first chip for execution.

19. The wafer-scale chip according to claim 18, wherein the transfer subunit has circuitry configured to:
receive second transfer information transmitted by the third chip in response to the second request information; and
execute a task of transferring from the third chip to the first chip based on the second transfer information.

20. The wafer-scale chip according to claim 18, wherein the task transfer condition comprises:
a difference between the task execution progress of the first chip and the task execution progress of the third chip is greater than an execution progress threshold;
or
a difference between a predicted time for the second chip to execute the remaining tasks and a predicted time for the first chip to execute the remaining tasks is greater than a time threshold.
